(19) United States
(12) Patent Application Publication
(10) Pub. No.: US 2015/0066472 A1
(43) Pub. Date: Mar. 5, 2015

(54) METHOD AND APPARATUS FOR GENERATING MULTIPLE PHONEME STRINGS FOR FOREIGN NOUN

(71) Applicant: Electronics and Telecommunications Research Institute, Daejeon (KR)

(72) Inventors: Min-Kyu LEE, Daejeon (KR); Sang-Hun KIM, Daejeon (KR); Seung YUN, Daejeon (KR); Cheol-Soon YI, Daejeon (KR)

(73) Assignee: Electronics and Telecommunications Research Institute, Daejeon (KR)

(21) Appl. No.: 14/244,044

(22) Filed: Apr. 3, 2014

(30) Foreign Application Priority Data
Sep. 4, 2013 (KR) 10-2013-0105820

(51) Int. Cl. G06F 17/28; G10L 15/02

(52) U.S. Cl. CPC G06F 17/289; G10L 15/02
USPC 704/2

(57) ABSTRACT

A method for generating multiple phoneme for foreign proper nouns according to the present invention comprises: converting a second language proper noun uttered in a first language to a second language word using an automatic translator; generating second language phoneme strings corresponding to the second language word using a second language G2P; converting the second language phoneme strings to first language phoneme strings; generating first language phoneme strings corresponding to the second language proper noun uttered in the first language using a first language G2P; and generating a plurality of phoneme strings by using the first language phoneme strings obtained through the step of converting to the first language phoneme strings and the first language phoneme strings obtained through the step of generating the first language phoneme strings.

### CROSS REFERENCE TO RELATED APPLICATION

This application claims the benefit of Korean Patent Application No. 10-2013-0105820, filed on Sep. 4, 2013, entitled “Method and apparatus for generating multiple phoneme strings for foreign proper noun”, which is hereby incorporated by reference in its entirety into this application.

### BACKGROUND OF THE INVENTION

1. Technical Field

The present invention relates to a speech recognition technology and more particularly, to a method and apparatus for generating multiple phoneme strings for a foreign proper noun for speech recognition or automatic translation.

2. Description of the Related Art

Recent speech recognition systems have been developed toward multilingual speech recognition systems recognizing speeches in multiple languages, not just one language. Thus, acoustic and language models generated by collecting speech data and language data of an individual language are demanded for multilingual speech recognition systems. However, there are not enough speech data and language data for foreign proper nouns due to their nature. For example, when a native language is English and a foreign language is Korean, an English speech recognizer cannot easily recognize utterance of a Korean proper noun such as ‘Gangnam( [symbol] )’, which is the district south of the Han River in Seoul. It requires having an accurate phoneme string along with corresponding speech in order to properly recognize a foreign proper noun. However, it requires lots of time and cost since operations for such purposes are conducted manually. In addition, notation of a foreign proper noun is not even unified since Romanization of foreign proper nouns are not unified or are changed. For example, English notation for ‘ [symbol] ’ (which is Gangnam in Korean) can be ‘Gangnam’, ‘Kangnam’ or the like.

There should be an accurate pronunciation dictionary for words in order to recognize speeches in a speech recognizer. Phoneme strings for words have been automatically generated through a grapheme to phoneme (G2P) system in order to produce a pronunciation dictionary for conventional speech recognizers or automatic translators. It allows reducing time and cost by automatically generating phoneme strings for words with this method.

However, when phoneme strings of a foreign proper noun generated through a native language G2P are used for a speech recognizer, it is difficult to expect proper speech recognition performance due to inaccurate phoneme strings since notation and actual pronunciation of a foreign proper noun do not match in many cases. For example, a Korean proper noun, ‘ [symbol] ’ (which is Gangnam in Korean), can be written as ‘Gangnam’ or ‘Kangnam’ in English and it can be pronounced by a non-native Korean in several utterances such as ‘ [symbol] ’, ‘ [symbol] ’, ‘ [symbol] ’, ‘ [symbol] ’ which are all different utterances of ‘Gangnam’ in Korean. If even such phoneme strings are generated through an English G2P, it can be another factor of poor speech recognition performance since they are different from actual pronunciations. Furthermore, Romanization is not even unified for one foreign proper noun so that various notations can be made which further causes losses in n-gram.

A method for unifying a foreign proper noun to one utterance by creating phoneme strings manually by an expert has been introduced in order to resolve such problems. However, it requires lots of time and cost. It even requires extra cost and time whenever a new proper noun is added which thus cannot deal effectively to develop multilingual speech recognizers.

### SUMMARY

An object of the present invention is to provide a method and an apparatus for efficiently and automatically generating phoneme strings for a foreign proper noun to improve performances of speech recognizers or automatic translators.

In order to achieve the above mentioned object, there is provided a method for generating multiple phoneme strings for a foreign proper noun comprising: converting a second language proper noun uttered in a first language to a second language word using an automatic translator; generating second language phoneme strings corresponding to the second language word using a second language G2P; converting the second language phoneme strings to first language phoneme strings; generating first language phoneme strings corresponding to the second language proper noun uttered in the first language using a first language G2P; and generating a plurality of phoneme strings by using the first language phoneme strings converted from the second language phoneme strings and the first language phoneme strings generated corresponding to the second language proper noun uttered in the first language.

In the step of converting to a second language word, a plurality of first language utterances for the second language proper noun may be converted to one second language word.

In the step of generating first language phoneme strings, first language phoneme strings corresponding to each of the plurality of first language utterances for the second language proper noun may be generated.

In the step of generating plurality of phoneme strings, differences between the first language phoneme strings converted from the second language phoneme strings and the first language phoneme strings generated corresponding to the second language proper noun uttered in the first language may be determined and combined to generate the plurality of phoneme strings.

In the step of determining differences, a dynamic programming may be used.

In order to achieve the object of the present invention, there is provided an apparatus for generating multiple phoneme strings for a foreign proper noun comprising: an automatic translator converting a second language proper noun uttered in a first language to a second language word; a second language G2P generating second language phoneme strings corresponding to the second language word; a phoneme string conversion unit converting the second language phoneme strings to first language phoneme strings; a first language G2P generating first language phoneme strings corresponding to the second language proper noun uttered in the first language; and a phoneme string generation unit generating a plurality of phoneme strings by using the first language phoneme strings converted by the phoneme string conversion unit and the first language phoneme strings generated by the first language G2P.

The automatic translator may convert a plurality of first language utterances for the second language proper noun to one second language word.

The first language G2P may generate first language phoneme strings corresponding to each of the plurality of first language utterances for the second language proper noun.

The phoneme string generation unit may determine differences between the first language phoneme strings converted by the phoneme string conversion unit and the first language phoneme strings generated by the first language G2P, and combine the differences to generate the plurality of phoneme strings.

According to the present invention described above, accurate and various phoneme strings for a foreign proper noun can be automatically and efficiently generated and the performance of speech recognizers or automatic translators is further improved.

Furthermore, it significantly reduces operation time and cost, compared to conventional methods for generating phoneme strings for a foreign proper noun which are operated manually.

It further increases n-gram hit ratio for a corresponding proper noun in language models by unifying various utterances of a foreign proper noun.

### BRIEF DESCRIPTION OF THE DRAWINGS

FIG. 1 illustrates a configuration of an apparatus for generating multiple phoneme strings for a foreign proper noun according to an embodiment of the present invention.

FIG. 2 illustrates examples of English utterances of Korean proper nouns input to an automatic translator 110 and their Korean words converted through the automatic translator 110.

FIG. 3 illustrates examples 301 of generation of Korean phoneme strings corresponding to Korean words through a second language G2P 120 and examples of conversion of Korean phoneme strings into English phoneme strings through a phoneme string conversion unit 130.

FIG. 4 illustrates examples of generation of English phoneme strings corresponding to English utterances of Korean proper nouns through a first language G2P 140.

FIG. 5 illustrates an example of operation of a phoneme string generation unit 150.

FIG. 6 illustrates a process of determining the differences between two phoneme strings using a dynamic time warping (DTW).

FIG. 7 is flowchart illustrating a method for generating multiple phoneme strings for a foreign proper noun according to an embodiment of the present invention.

### DESCRIPTION OF THE EXEMPLARY EMBODIMENTS

Hereinafter, embodiments of the present invention will be described with reference to the accompanying drawings, in which those components are rendered the same reference number that are the same or are in correspondence, regardless of the figure number, and redundant explanations are omitted. Throughout the description of the present invention, when describing a certain technology is determined to evade the point of the present invention, the pertinent detailed description will be omitted

Such terms as ‘a first language’ and ‘a second language’, which are used in embodiments of the present invention, mean different languages each other in which the first language may be a native language and the second language may be a foreign language. The first language and the second language may be any language but for convenience of explanation, it will be explained with an example of that the first language is English and the second language is Korean.

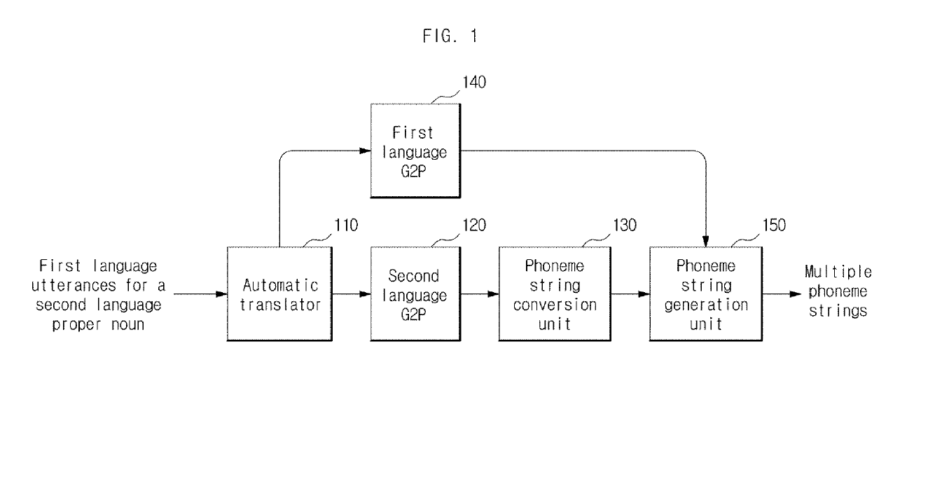

FIG. 1 illustrates a configuration of an apparatus for generating multiple phoneme strings for a foreign proper noun according to an embodiment of the present invention. An apparatus for generating multiple phoneme strings according to an embodiment of the present invention, as shown in FIG. 1, is configured to include an automatic translator 110, a second language G2P 120, a phoneme string conversion unit 130, a first language G2P 140 and a phoneme string generation unit 150.

A second language proper noun uttered in a first language is input to or is pre-provided into the apparatus for generating multiple phoneme strings according to an embodiment of the present invention. The second language proper noun uttered in a first language may be a Korean proper noun uttered in English. According to this embodiment, the first language utterance for one second language proper noun can be two or more. For example, English utterance for Korean proper noun ‘ [symbol] ’ (which is Gangnam in Korean) can be ‘Gangnam’ and ‘Kangnam’.

The automatic translator 110 converts a second language proper noun uttered in a first language to a second language word. For example, the automatic translator 110 converts a Korean proper noun uttered in English to a Korean word. According to this embodiment, when a plurality of first language utterances for one second language proper noun are input to the automatic translator 110, the automatic translator 110 can convert the plurality of first language utterances to one second language word. For example, if ‘Gangnam’ and ‘Kangnam’ are input as English utterances for a Korean proper noun ‘ [symbol] ’ (which is Gangnam in Korean), the automatic translator 110 outputs ‘ [symbol] ’ (which is Gangnam in Korean) as one Korean word by translating both ‘Gangnam’ and ‘Kangnam’. An operation of the automatic translator 110 unifies various native utterances for a certain foreign proper noun into one foreign language word.

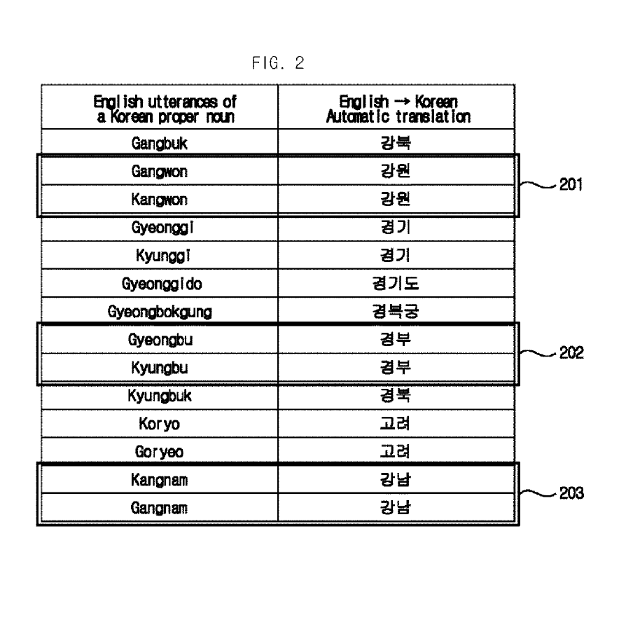

FIG. 2 illustrates examples of English utterances of Korean proper nouns input to an automatic translator 110 and their Korean words converted through the automatic translator 110. Referring to FIG. 2, each of ‘ [symbol] ’ 201, ‘ [symbol] ’ 202, and ‘ [symbol] ’ 203 of Korean proper nouns has a plurality of English utterances which are further converted into one corresponding Korean word.

As shown in FIG. 2, English utterances of a Korean proper noun can be various according to Romanization. When there are various English utterances for one Korean proper noun, a corresponding word can be several words in language modeling so that it causes inaccurate modeling, resulting in poor recognition performance. However, according to an embodiment, various English utterances for one Korean proper noun can be mapped to one Korean word through the automatic translator 110 so that it allows accurate modeling for a corresponding word.

Referring to FIG. 1 again, the second language G2P 120 generates second language phoneme strings corresponding to the second language word output from the automatic translator 110. Namely, the phoneme strings generated through the second language G2P 120 is phoneme strings configured with a phoneme set of the second language.

For example, the second language G2P 120 is a Korean G2P and generates Korean phoneme strings corresponding to the Korean word output from the automatic translator 110. For example, when a Korean word ‘ [symbol] ’ (which is Gangnam in Korean) is output from the automatic translator 110, the second language G2P 120 generates Korean phoneme strings ‘g a N n a m’ corresponding to ‘ [symbol] ’ (which is Gangnam in Korean).

The phoneme string conversion unit 130 converts the second language phoneme strings generated from the second language G2P 120 into first language phoneme strings. The phoneme string conversion unit 130 may convert the second language phoneme strings into the first language phoneme strings by utilizing correspondence between a phoneme set of the second language and a phoneme set of the first language.

For example, the phoneme string conversion unit 130 converts the Korean phoneme strings generated from the second language G2P 120 into English phoneme strings. For example, when the Korean phoneme string ‘g a N n a m’ is output from the second language G2P 120, the phoneme string conversion unit 130 converts it into corresponding English phoneme ‘G AA NG N AA M’.

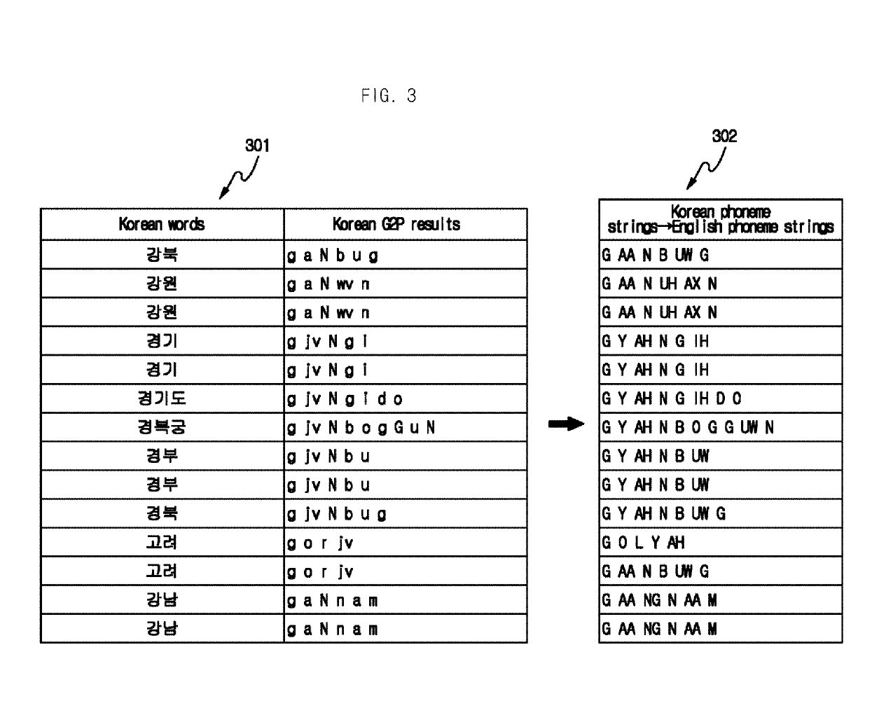

FIG. 3 illustrates examples 301 of generation of Korean phoneme strings corresponding to Korean words through a second language G2P 120 and examples 302 of conversion of Korean phoneme strings into English phoneme strings through a phoneme string conversion unit 130.

Referring to FIG. 1 again, the first language G2P 140 generate first language phoneme strings corresponding to a second language proper noun uttered in a first language. For example, the first language G2P 140 is an English G2P and generates English phoneme strings corresponding to a Korean proper noun uttered in English. According to an embodiment, when a plurality of first language utterances for one second language proper noun are input to the first language G2P 140, the first language G2P 140 generates first language phoneme strings corresponding to each of the plurality of first language utterances.

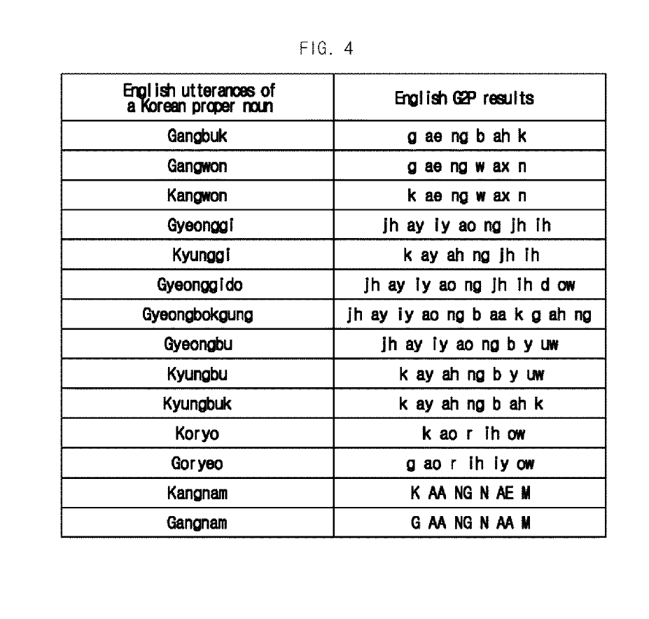

FIG. 4 illustrates examples of generation of English phoneme strings corresponding to English utterances of a Korean proper noun through the first language G2P 140. For example, when ‘Gangnam’ and ‘Kangnam’ are input as English utterances for the Korean proper noun ‘ [symbol] ’ (which is Gangnam in Korean), the first language G2P 140 generates English phoneme strings of ‘G AA NG N AA M’ and ‘K AA NG N AE M’ corresponding to each of ‘Gangnam’ and ‘Kangnam’.

The phoneme string generation unit 150 generates a plurality of phoneme strings by using the first language phoneme strings generated through the phoneme string conversion unit 130 and the first language phoneme strings generated through the first language G2P 140. For example, the phoneme string generation unit 150 generates a plurality of phoneme strings by using English phoneme strings generated through the phoneme string conversion unit 130 and English phoneme strings generated through the English G2P 140.

English phoneme strings output through the English G2P 140 are phoneme strings obtained through the English G2P from the English utterances of a Korean word. English phoneme strings thus are generated by reflecting with various pronunciations which can be appeared when a non-native Korean pronounces a Korean proper noun.

On the other hand, the English phoneme strings output through the phoneme string conversion unit 130 are phoneme strings obtained by converting English utterances of a Korean proper noun into a Korean word through an automatic translator, generating Korean phoneme strings through the Korean G2P and converting the Korean phoneme strings into corresponding English phoneme strings. The Korean phoneme strings obtained through the Korean G2P correspond to Korean phoneme strings which are close to actual pronunciation of the Korean proper noun, while the phoneme strings obtained by converting the Korean phoneme strings into the English phoneme strings correspond to English phoneme strings which are close to actual pronunciation of the Korean proper noun.

The English phoneme strings output through the English G2P 140 and the English phoneme strings output through the phoneme string conversion unit 130 may be overlapped in some cases but generally different. Thus, when a plurality of phoneme strings are generated using all of those, more various and accurate English phoneme strings of a Korean proper noun can be generated.

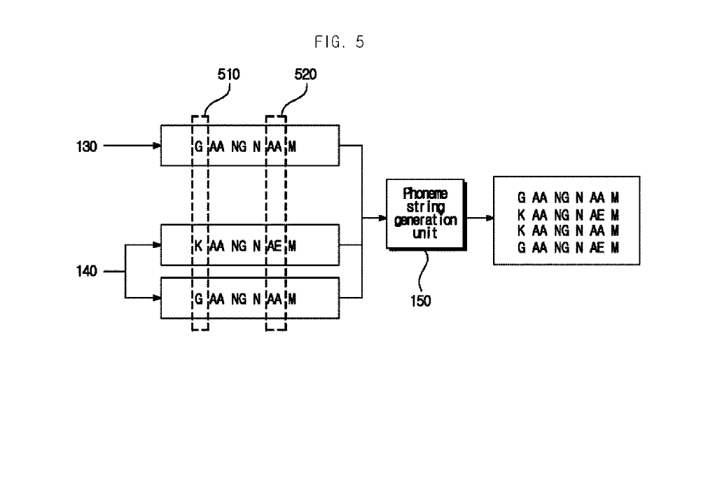

In an embodiment of the present invention, the phoneme string generation unit 150 determines different parts between the first language phoneme strings obtained through the phoneme string conversion unit 130 and the first language phoneme strings obtained through the first language G2P 140 and combines those different parts to generate a plurality of phoneme strings. FIG. 5 illustrates an example of operation of a phoneme string generation unit 150.

Referring to FIG. 5, ‘G AA NG N AA M’ is the English phoneme string obtained through the phoneme string conversion unit 130 and ‘K AA NG N AE M’ and ‘G AA NG N AA M’ are the English phoneme strings obtained through the first language G2P 140. Accordingly, the different parts in the English phoneme strings are the first phoneme 510 and the fifth phoneme 520. When the first phoneme 510 and the fifth phoneme 520 are combined, 4 English phoneme strings of ‘G AA NG N AA M’, ‘K AA NG N AE M’, ‘K AA NG N AA M’ and ‘G AA NG N AE M’ are generated.

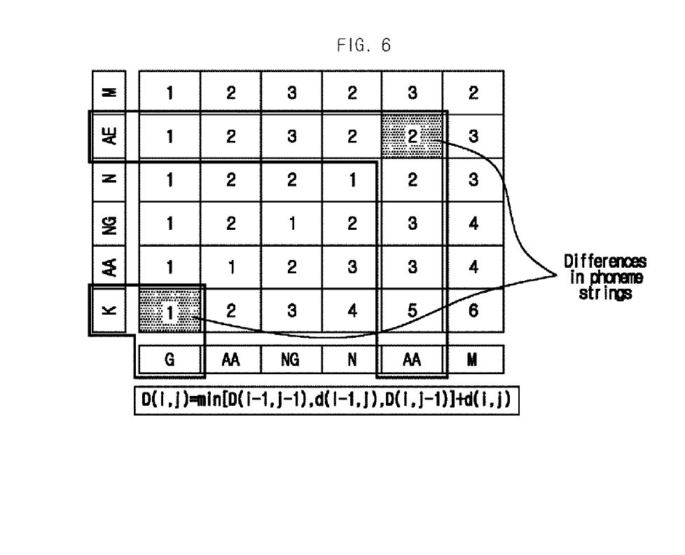

Known various algorithms can be used to determine 2 or more of different parts in phoneme strings by the phoneme string generation unit 150. For example, a dynamic programming algorithm such as dynamic time warping (DTW) can be used. FIG. 6 illustrates a process of determining the differences between two phoneme strings of ‘G AA NG N AA M’ and ‘K AA NG N AE M’ using the dynamic time warping (DTW). Referring to FIG. 6, the differences in two phoneme strings are the first phoneme of ‘K’ and ‘G’ and the fifth phoneme of ‘AE’ and ‘AA’.

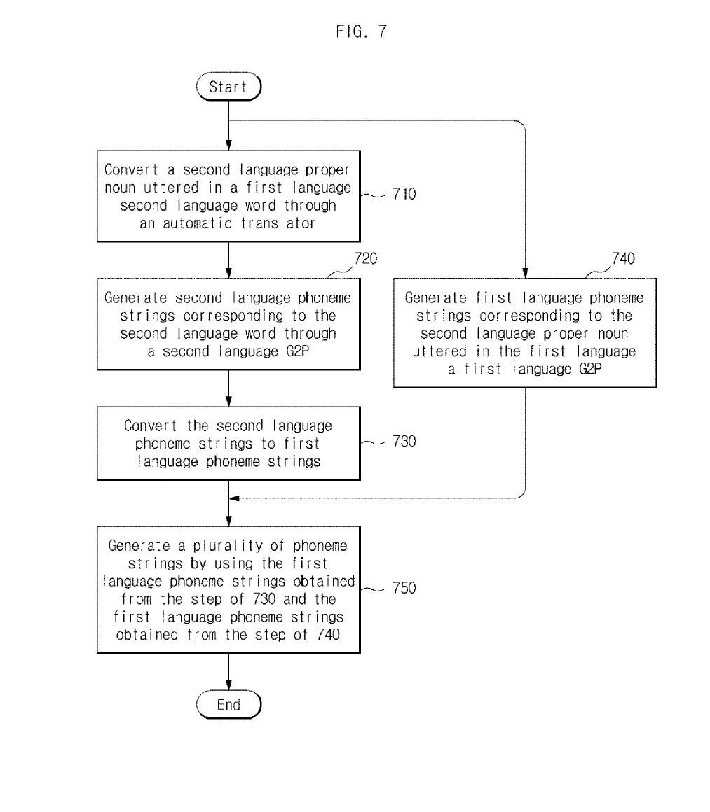

FIG. 7 is flowchart illustrating a method for generating multiple phoneme strings for a foreign proper noun according to an embodiment of the present invention. The method for generating multiple phoneme strings according to an embodiment of the present invention comprises steps of operations of the apparatus of the present invention. Therefore, descriptions on the apparatus for generating multiple phoneme strings will be applied to those for the method for generating multiple phoneme strings.

In 710, the apparatus for generating multiple phoneme strings converts a second language proper noun uttered in a first language into a second language word through an automatic translator.

In 720, the apparatus for generating multiple phoneme strings generates second language phoneme strings corresponding to the second language word obtained from the step of 710 through a second language G2P.

In 730, the apparatus for generating multiple phoneme strings converts the generated second language phoneme strings to first language phoneme strings.

In 740, the apparatus for generating multiple phoneme strings generates first language phoneme strings corresponding to the second language proper noun uttered in the first language through a first language G2P.

In 750, the apparatus for generating multiple phoneme strings generates a plurality of phoneme strings by using the first language phoneme strings obtained through the step of 730 and the first language phoneme strings obtained through the step of 740.

According to an embodiment of the present invention, it can generate various phoneme strings which can be uttered for a foreign proper noun. In addition, since multiple phoneme strings for a foreign proper noun are generated by combining phoneme strings generated through a native language G2P and phoneme strings generated through a foreign language G2P, recognition performance for a word uttered in inaccurate pronunciation can be significantly improved by using such multiple phoneme strings. Furthermore, when the present invention is applied to automatic translations which use speech recognition and include lots of utterances for foreign proper nouns, its speech recognition performance can be significantly improved.

The exemplary embodiments of the present invention described herein above can be programmable to be executed by a computer and can be implemented in general-use digital computers which operate the program by using computer readable recording media. An example of the computer readable recording media may include storage media such as magnetic storage media (such as ROMs, floppy disks, hard disks and the like) and optical readable media (such as CD-ROMs, DVDs and the like).

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents. The scope of the present invention should be interpreted by the following claims and it should be interpreted that all spirits equivalent to the following claims fall with the scope of the present invention.

What is claimed is:

1. A method for generating multiple phoneme strings for a foreign proper noun comprising:
converting a second language proper noun uttered in a first language to a second language word using an automatic translator;
generating second language phoneme strings corresponding to the second language word using a second language G2P;
converting the second language phoneme strings to first language phoneme strings;
generating first language phoneme strings corresponding to the second language proper noun uttered in the first language using a first language G2P; and
generating a plurality of phoneme strings by using the first language phoneme strings converted from the second language phoneme strings and the first language phoneme strings generated corresponding to the second language proper noun uttered in the first language.

2. The method of claim 1, wherein the converting of the second language proper noun to the second language word includes converting a plurality of first language utterances for the second language proper noun to one second language word.

3. The method of claim 2, wherein the generating of the first language phoneme includes generating first language phoneme strings corresponding to each of the plurality of first language utterances for the second language proper noun.

4. The method of claim 1, wherein the generating of the plurality of phoneme strings includes determining differences between the first language phoneme strings converted from the second language phoneme strings and the first language phoneme strings generated corresponding to the second language proper noun uttered in the first language and combining the differences to generate the plurality of phoneme strings.

5. The method of claim 4, wherein the determining of differences uses a dynamic programming.

6. An apparatus for generating multiple phoneme strings for foreign proper noun comprising:
an automatic translator converting a second language proper noun uttered in a first language to a second language word;
a second language G2P generating second language phoneme strings corresponding to the second language word;
a phoneme string conversion unit converting the second language phoneme strings to first language phoneme strings;
a first language G2P generating first language phoneme strings corresponding to the second language proper noun uttered in the first language; and
a phoneme string generation unit generating a plurality of phoneme strings by using the first language phoneme strings converted by the phoneme string conversion unit and the first language phoneme strings generated by the first language G2P.

7. The apparatus of claim 6, wherein the automatic translator converts a plurality of first language utterances for the second language proper noun to one second language word.

8. The apparatus of claim 7, wherein the first language G2P generates first language phoneme strings corresponding to each of the plurality of first language utterances for the second language proper noun.

9. The apparatus of claim 6, wherein the phoneme string generation unit determines differences between the first language phoneme strings converted by the phoneme string conversion unit and the first language phoneme strings generated by the first language G2P and combines the differences to generate the plurality of phoneme strings.

10. The apparatus of claim 9, wherein the differences are determined by using a dynamic programming.
